(19) United States
(12) Patent Application Publication
(10) Pub. No.: US 2004/0150180 A1
(43) Pub. Date: Aug. 5, 2004

(54) Wheel tensioning mechanism

(75) Inventors: Thomas E. Fish JR., Wickliffe, OH (US); Thomas W. Walraven, Cuyahoga Falls, OH (US)

Correspondence Address: Don W. Bulson, Esq., Renner, Otto, Boisselle & Sklar, 1621 Euclid Avenue, 19th Floor, Cleveland, OH, 44115, US

(73) Assignee: The Little Tikes Company, a corporation of the State of Ohio

(21) Appl. No.: 10/355,697

(22) Filed: Jan. 31, 2003

(51) Int. Cl. B62B 7/00

(52) U.S. Cl. 280/87.051

(57) ABSTRACT

A device that provides resistance to the wheels of a children's toy. The device includes an axle with a first wheel attached to one end of the axle and a second wheel attached to a second end of the axle. A cam with an outwardly extending lever is positioned on the axle adjacent to one of the wheels. The lever rotates the cam which brings the cam closer to the wheel thereby increasing the rolling resistance of the wheel.

### TECHNICAL FIELD OF THE INVENTION

This invention relates generally to a children's walker, and, more particularly to a wheel tensioning mechanism for a children's walker.

### BACKGROUND OF THE INVENTION

Before a child is able to walk independently, the child may use a walker or ride-on toy to develop balance and coordination skills that are necessary to walk independently. Walkers and ride-on toys typically include handles that allow a child to hold on to the toy while standing. The handle provides support for the child when the child stands stationary adjacent to the toy. The handle also provides support when the child pushes the toy forward as the child takes their first steps. Often, depending on the contact surface, the walker or ride-on toy moves too quickly for the child. As a result, the toy slides out or away from the child. In this instance, a child would typically loose their balance and fall to the floor. Thus, when the walker or ride-on toy is placed on a smooth surface, such as linoleum, hardwood or a tile floor, the child may injure themselves when the walker or ride-on toy moves too quickly.

The prior art includes strollers and baby carriages with brake mechanisms. The brake mechanism typically includes pins which enter between yokes of a wheel, causing the wheel to be maintained in a braked or locked position. Examples of this type of braking mechanism are illustrated in U.S. Pat. Nos. 5,373,917; 6,408,990; and 6,443,468. However, these braking mechanisms do not address the concerns noted above.

Accordingly, it is an object of the invention to provide a wheel tensioning mechanism to be used with a walker or any similar device.

It is an object of the invention to provide a wheel tensioning mechanism that allows a parent to adjust the rolling resistance of the wheels of the walker depending on the type of contact surface.

It is an object of the invention to provide a wheel tensioning mechanism that allows a parent to adjust the rolling resistance of the wheels of the walker depending on the developmental level of the child using the walker.

It is another object of the invention to provide a wheel tensioning mechanism for a walker or similar device that is easy to adjust between resistance levels.

These and other objects of the present invention, as well as the advantages thereof over existing prior art forms, which will become apparent from the description to follow, are accomplished by the improvements herein after described and claimed.

### SUMMARY OF THE INVENTION

The present invention provides a device for adjusting the resistance of the wheels of a children's toy. The device includes an axle positioned within the children's toy. A first wheel is attached to one end of the axle and a second wheel is attached to a second end of the axle. A cam that has an outwardly extending lever is positioned on the axle adjacent to one of the wheels. The lever rotates the cam which draws the cam closer to the wheel thereby increasing the rolling resistance of the wheel.

The present invention also provides a children's toy formed from a base having a front, back, a first side and a second side. An axle is positioned within a lower portion of the base of the walker such that the axle extends from the first side to the second side. A first wheel is attached to a first end of the axle and a second wheel is attached to a second end of the axle. A cam with an outwardly extending lever is positioned on the axle adjacent to one of the wheels. The lever rotates the cam to draw the cam closer to the wheel thereby increasing the rolling resistance of the wheel.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 illustrates an isometric view of a children's walker with the wheel tensioning mechanism of the present invention;

FIG. 2 illustrates a front view of a children's walker with the wheel tensioning mechanism of the present invention;

FIG. 3 illustrates a front view of the wheel tensioning mechanism illustrated in the walker of FIG. 2;

FIG. 4 illustrates a right perspective exploded view of the wheel tensioning mechanism of the present invention;

FIG. 5 illustrates a left perspective exploded view of the wheel tensioning mechanism of the present invention; and

FIG. 6 illustrates an exploded view of an alternative embodiment of the wheel tensioning mechanism of the present invention.

### DETAILED DESCRIPTION

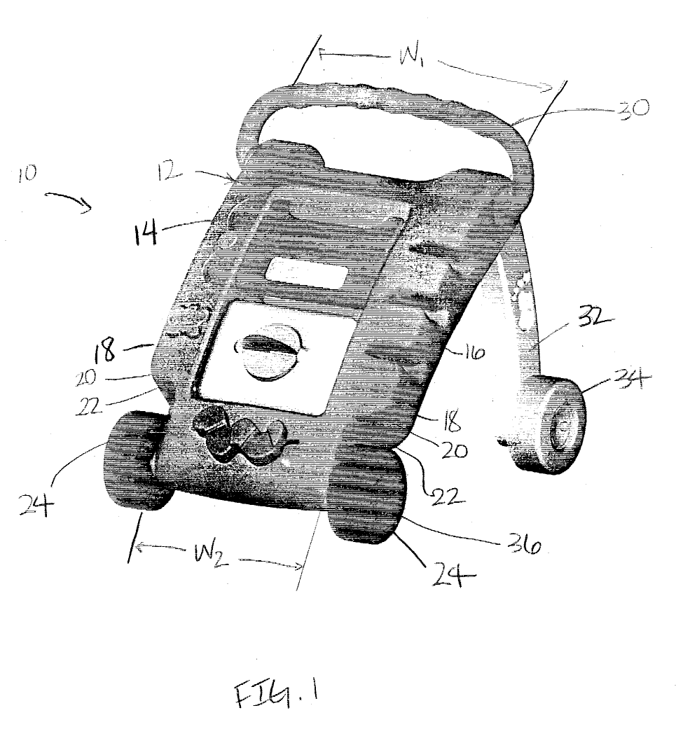

FIG. 1 illustrates a children's walker with the wheel tensioning mechanism of the present invention. The walker, shown generally at 10, includes a base 12 having a front 14, a back 16 and sides 18. The walker also includes a handle 30 and two outwardly extending back legs 32. Each outwardly extending leg includes a back wheel 34.

The sides 18 are spaced apart so as to define a first width, W1. At the bottom 20 of each side 18, there is a step 22 that leads to second side portion 24. The second side portions 24 are spaced apart so as to define a second width, W2. The front wheels 36 of the walker may be positioned within the area below the first sides 18 and adjacent to the second side portion 24. The wheels 36 are initially positioned such that they are free to rotate without contacting the side portion 24 or the step 22 of the base 12.

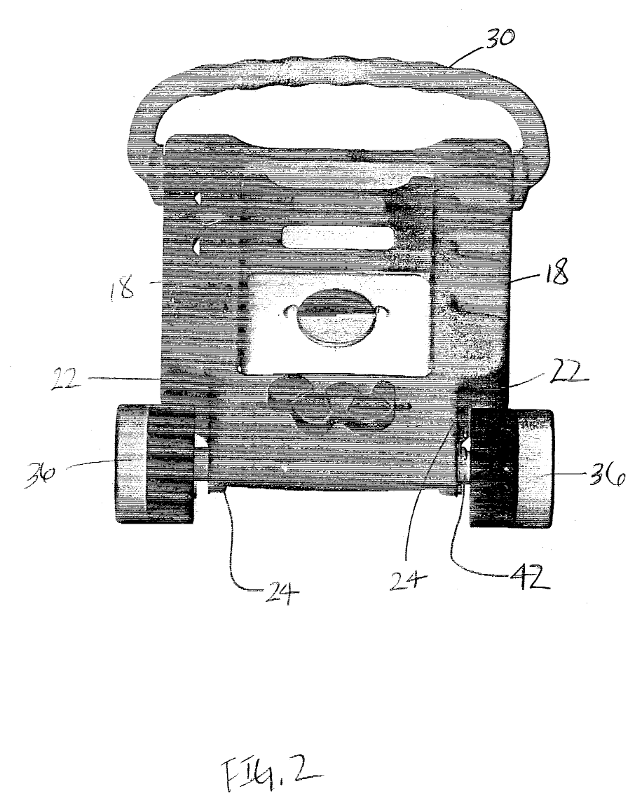

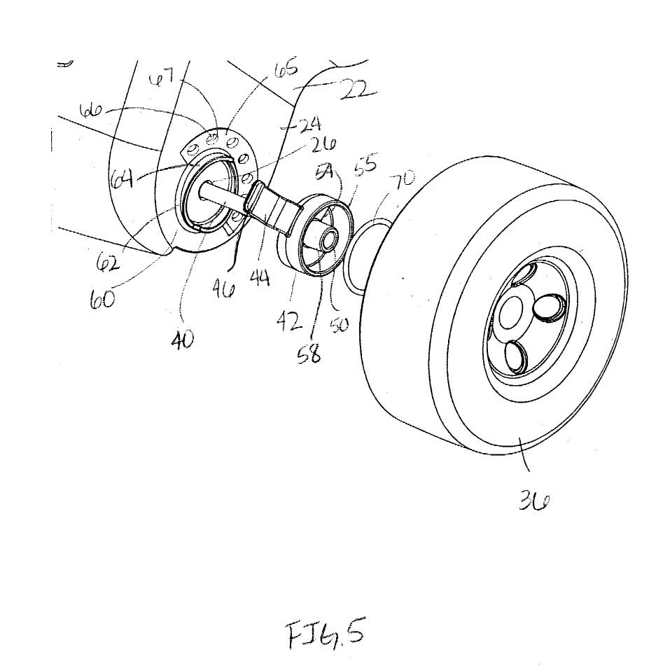

The wheel tensioning mechanism of the present invention controls the resistance of the front wheels of the walker by applying pressure to both of the front wheels evenly. Each second side portion 24 of the base includes an opening 26 (see FIG. 5). The openings 26 of each side portion are aligned so as to receive an axle 40. Thus, the axle 40 extends from one side portion 24 to the other side portion. The axle 40 is formed from a metal, such as 1020 steel. As shown in FIG. 2, one wheel 36 is attached to each side of the axle 40.

As will be appreciated more fully from the following, the length of the axle 40 is selected based on the width W2 of the walker and the width of the component assembled onto the axle 40.

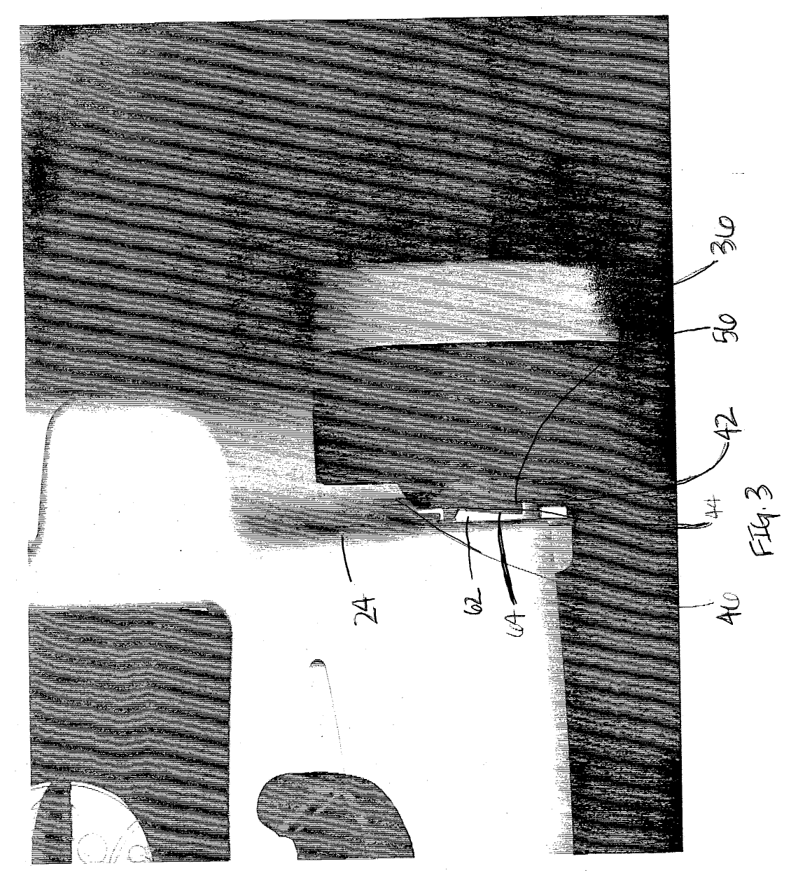

Also shown in FIG. 2 and shown in more detail in FIG. 3, a cam 42 having an outwardly extending lever 44 is positioned at one end of the axle 40 between the side portion 24 of base 12 and one of the wheels 36. In the illustrated embodiment, the cam is placed on the left side, i.e. the driver's side, of the walker. Since the wheels are attached to the same axle 40, only one cam is necessary to control the resistance of the wheels.

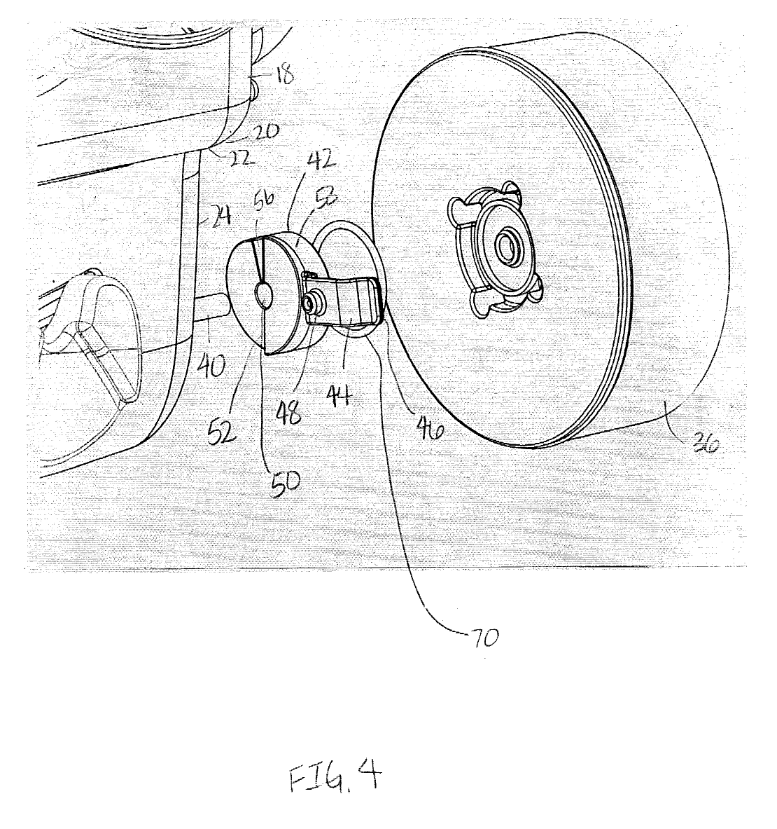

FIGS. 4 and 5 are an exploded view of the wheel tensioning mechanism of the present invention. The cam 42 is disc shaped with a first side 52 having an outer edge 53 and a second side 54 having an outer edge 55 (see FIG. 5). The first side 52 of the cam includes a raised inclined portion 56 (see FIG. 4). The second side 54 of the cam is partially hollow. The cam also includes a hole 50 through the center of the cam. As shown in FIG. 5, a cylindrical portion 58 extends from the outer edge 53 of the first side 52 to the outer edge 55 of the second side 54. The cylindrical portion 58 is defined by the hole 50 in the center of the cam. The cylindrical portion 58 houses the axle 40 when the wheel tensioning mechanism is assembled.

A lever 44 extends outwardly from the periphery of the cam 42. The lever 44 is positioned in an area that is opposite that of the raised inclined portion 56 of the cam. The end of the lever includes a lifting tab 46. The lifting tab 46 enables the user to engage the lever 44 for rotation. A cylindrical protrusion 48 extends outwardly from the lever towards the base of the walker. The protrusion 48 may be formed from various shapes, such as a rectangular tab, so long as the protrusion matingly engages the engagement surface 60 of the side portion 24 of the walker.

The engagement surface 60 of side portion 24 of the walker is illustrated in FIG. 5. The engagement surface 60 includes a housing 62 having a raised outer ring 64. The outer ring 64 is partially inclined so that it matingly engages the cam 42 when the wheel tension mechanism is assembled and the lever is positioned near the front of the walker (see FIG. 3).

The engagement surface 60 also includes an arcuate projection 65 having a plurality of openings 66 that lead to cavities 67 formed therein. The openings and cavities formed in the arcuate projection form an arcuate path around the housing of the engagement surface. The arcuate projection 65 is also inclined to enable the lever and inclined cam to rotate to the desired opening. In the illustrated embodiment, the openings are circular with each opening 66 having an identical shape. However, the openings and the cavities may be formed from a variety of shapes.

As shown in FIG. 5, there are a plurality of openings that are spaced a distance from each other to enable the resistance of the front wheels to be adjusted. Each opening is sized to receive the outwardly extending protrusion 48 of the lever 44. The number of openings in the engagement surface may also vary thereby providing the user with a number of options for adjusting the resistance level of the front wheels of the walker.

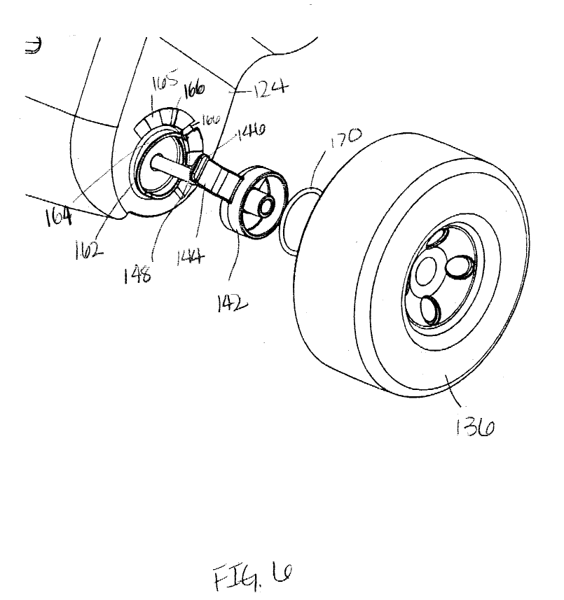

Alternatively, as illustrated in FIG. 6, the engagement surface 160 of the side portion 124 may include an inclined arcuate projection 165 having a plurality of ribs or teeth 166. The ribs are aligned along the engagement surface such that they protrude outwardly from the arcuate projection. The number and position of the ribs may also vary similar to the openings illustrated in FIG. 5. This would enable the user to adjust the resistance of the wheel tensioning mechanism to a plurality of levels. In this alternative embodiment, the lever 144 would include an outwardly extending rectangular shaped protrusion 148 that would matingly engage the ribs of the arcuate projection 165. The aligned ribs would enable the user to simply adjust the resistance level by pushing the lever so that the protrusion contacts an adjacent rib.

The rolling resistance of the wheels is measured by the force due to the weight of the walker and the friction of the moving parts of the walker that acts opposite to an externally applied force by the child to move the walker forward or backward. The resistance of the wheels is controlled by the frictional contact between the moving parts of the walker. The resistance of the front wheels is increased as the lever and cam are rotated clockwise towards the back of the walker. Conversely, the resistance of the front wheels is decreased as the lever and cam are rotated towards the front of the walker.

To use the wheel tensioning mechanism of the present invention, the user engages the lifting tab of the lever. As the lifting tab is raised, the outwardly extending protrusion of the lever is lifted out of one of the openings in the engagement surface. The user is now free to rotate the lever either clockwise or counterclockwise depending on the desired resistance level for the front wheels.

As the lever is rotated clockwise, the cam rotates away from its mating engagement with the housing in the engagement surface on the driver's side of the walker. As a result, as the lever rotates the cam, the cam is pushed towards the inner surface of the front wheel. As the cam rotates, it pushes an O-ring or elastomer gasket 70 that is positioned adjacent to the wheel closer to the driver's side front wheel.

As the driver's side front wheel is displaced, the opposing wheel is pulled by the axle towards the side portion of the passenger side of the walker. This creates even pressure on both front wheels. The amount of pressure created will be dependent on the position of the cam. Although the cam is placed on the driver's side of the walker, the wheel tensioning mechanism could be designed so that the cam is located on the passenger side of the walker instead.

The compressible O-ring or elastomer gasket 70 is preferably made from polyvinyl chloride (PVC) or a SANTOPRENE elastomer, however it could be made from a foam or other elastomer material. As the wheel rotates, the O-ring increases the friction generated between the cam, the O-ring and the wheel. The O-rings prevent the cam and the wheel, which are typically made from plastic, from rubbing against each other which would result in the failure of the plastic parts. Although it is preferable to position an O-ring adjacent to both wheels, the wheel tensioning mechanism would still perform with either one or no O-rings or elastomer gaskets.

Thus, the wheel tensioning mechanism allows the end-user to choose various settings to personalize the walker for each child. For example, if the child is just learning how to walk and if the contact surface is that of hardwood, the user would set the resistance level to the maximum resistance. This would provide a sufficient resistance to the wheels to control the toy from slipping away from the child. As the child develops or if the contact surface has traction, such as carpeting, the resistance level of the wheel may be adjusted counterclockwise, to allow the wheels to move more freely.

The mechanism of the present invention incorporates both plastic and elastomer materials. Having the parts of the device being made from plastic or an elastomer increases the longevity and compliments the performance of the toy. However, if desired, the mechanism could be made from other materials, such as wood or metal.

Although the wheel tensioning mechanism is illustrated on a child's walker, the wheel tensioning mechanism may be used on a variety of children's toys including ride-on toys and toy trucks.

It should now be apparent that the length of the axle 40 must be selected in order that the cam action will be effective. It will also be understood that the earn arrangement may be designed with an axle that does not extend from both front wheels. Each front wheel may be designed with separate independent axles. The cam arrangement may be utilized at both or one of the separate front axles. However, the benefit of the same braking pressure will be more difficult to accomplish with two cam arrangements, and will obviously not be available in a single cam arrangement.

While the preferred embodiment of this invention has been shown and described, it will be apparent to those skilled in the art that changes and modifications may be made therein without departing from the spirit of the invention, the scope of which is defined by the appended claims.

What is claimed is:

1. A device for providing adjustment to the resistance of movement in a children's toy, the device comprising:
a housing having a raised inclined surface;
an axle extending through the housing, and having a first end and a second end;
a first wheel positioned on the axle at the first end;
a cam positioned on the axle and adjacent the raised inclined surface of the housing; and
means for adjusting the angular position of the cam with respect to the raised inclined surface, whereby the angular position of the cam determines the tension imposed upon the wheel.

2. The device of claim 1, further comprising:
a second wheel positioned on the second end of the axle, whereby the angular position of the cam determines the tension imposed upon the wheels.

3. A device for providing resistance for a children's toy, the device comprising:
an axle;
a first wheel attached to one end of the axle;
a second wheel attached to a second end of the axle;
a cam positioned on the axle adjacent to one of the wheels; and
means for adjusting the angular position of the cam;
whereby the adjusting means rotates the cam bringing the cam closer to the wheel thereby increasing the rolling resistance of the wheels.

4. The device of claim 3, further comprising an elastomer member positioned adjacent to the first and second wheel.

5. The device of claim 4, wherein the elastomer member is an O-ring.

6. The device of claim 3, wherein the adjusting means has an outwardly extending lever with a lift tab for facilitating movement of the lever.

7. The device of claim 3, wherein the adjusting means has an outwardly extending lever with an outwardly extending protrusion for engaging a surface of the toy.

8. The device of claim 3, wherein the cam has a cylindrical member defined by an opening for housing the axle.

9. The device of claim 3, wherein the cam has a first and second side, the first side having an inclined surface for engaging a surface of the toy.

10. A children's toy comprising:
a base having a front, a back, a first side and a second side;
an axle positioned within a lower portion of the base extending from the first side to the second side;
a first wheel attached to a first end of the axle;
a second wheel attached to a second end of the axle; and
a cam having an outwardly extending lever, the cam is positioned on the axle adjacent to one of the wheels;
whereby the lever rotates the cam bringing the cam closer to the wheel thereby increasing the rolling resistance of the wheels of the children's toy.

11. The children's toy of claim 10, wherein one of the sides has an engagement portion disposed therein.

12. The children's toy of claim 11, wherein the engagement portion includes a plurality of openings.

13. The children's toy of claim 11, wherein the engagement portion includes a plurality of ribs.

14. The children's toy of claim 11, wherein the engagement portion includes a housing having a raised inclined surface.

15. The children's toy of claim 14, wherein the cam has a first side and a second side, the first side having an inclined surface for matingly engaging the housing of the toy.

16. The children's toy of claim 10, wherein a resistance level of the wheels is adjustable.

17. The children's toy of claim 10, further comprising an elastomer member positioned adjacent to the first wheel and the second wheel.

18. The children's toy of claim 17, wherein the elastomer member is an O-ring.

19. The children's toy of claim 10, wherein the lever has a lift tab for facilitating movement of the lever.

20. The children's toy of claim 10, wherein the lever has an outwardly extending protrusion for engaging the side of the toy.

21. The children's toy of claim 10, wherein the cam has an cylindrical member defined by an opening for housing the axle.

22. The children's toy of claim 10, wherein the cam pushes against the adjacent wheel as the axle pulls the opposing wheel towards the base.
